(19) United States
(12) Patent Application Publication
(10) Pub. No.: US 2017/0255834 A1
(43) Pub. Date: Sep. 7, 2017

(54) Distributed Pattern Processor Comprising Three-Dimensional Memory Array

(71) Applicant: Guobiao ZHANG, Corvallis, OR (US)

(72) Inventor: Guobiao ZHANG, Corvallis, OR (US)

(73) Assignee: HangZhou HaiCun Information Technology Co., Ltd., HangZhou (CN)

(21) Appl. No.: 15/452,728

(22) Filed: Mar. 7, 2017

(30) Foreign Application Priority Data
Mar. 7, 2016 (CN) 201610127981.5
Mar. 3, 2017 (CN) 201710122861.0
Mar. 7, 2017 (CN) 201710130887.X

(51) Int. Cl. G06K 9/00; G06F 21/56; G11C 5/02

(52) U.S. Cl. CPC G06K 9/00973; G11C 5/02; G06F 21/564; G06F 2221/032

(57) ABSTRACT

The present invention discloses a distributed pattern processor. The distributed pattern processor not only stores patterns permanently, but also processes them using massive parallelism. It comprises a plurality of storage-processing units (SPU), with each SPU comprising a pattern-processing circuit and at least a three-dimensional memory (3D-M) array storing at least a pattern. The 3D-M array is vertically stacked above the pattern-processing circuit.

### CROSS-REFERENCE TO RELATED APPLICATIONS

This application claims priorities from Chinese Patent Application No. 201610127981.5, filed Mar. 7, 2016; Chinese Patent Application No. 201710130887.X, filed Mar. 7, 2017, in the State Intellectual Property Office of the People's Republic of China (CN), the disclosures of which are incorporated herein by references in their entireties.

### Background

1. Technical Field of the Invention

The present invention relates to the field of integrated circuit, and more particularly to distributed pattern processor for massively parallel pattern matching or pattern recognition.

2. Prior Art

Pattern matching and pattern recognition are the acts of searching a target pattern (i.e. the pattern to be searched) for the presence of the constituents or variants of a search pattern (i.e. the pattern used for searching). The match usually has to be “exact” for pattern matching, whereas it could be “likely to a certain degree” for pattern recognition. Unless explicitly stated, the present invention does not differentiate pattern matching and pattern recognition. They are collectively referred to as pattern processing. In addition, search patterns and target patterns are collectively referred to as patterns.

Pattern processing has broad applications. Typical pattern processing includes string match, code match, voice recognition and image recognition. String match is widely used in big data analytics (e.g. financial data mining, e-commerce data mining, bio-informatics). Examples of string match include regular expression matching, i.e. searching a regular expression in a database. Code match is widely used in anti-malware operations, for example, searching a virus signature in a computer file, or checking if a network packet conforms to a set of network rules. Voice recognition matches a sequence of bits in the voice data with an acoustic model and/or a language model. Image recognition matches a sequence of bits in the image data with an image model.

The pattern database has become big: the search-pattern database (including all search patterns) is already big (on the order of GB); while the target-pattern database (including all target patterns) is even bigger (on the order of TB to PB, even EB). Pattern-processing for such a big database requires not only powerful processor, but also fast memory/storage. Unfortunately, the conventional von Neumann architecture cannot meet this requirement. In the von Neumann architecture, the processor is separated from the storage. The memory/storage (e.g. DRAM, solid-state drive, hard drive) only stores patterns, but does not process any of them. All pattern-processing is performed by the processor (e.g. CPU, GPU). As is well known in the art, there is a “memory wall” between the processor and the memory/storage, i.e. the communication bandwidth between them is limited. It takes hours to read a TB-scale data from a hard drive, let alone process it. This poses as a bottleneck to perform pattern processing for a big pattern database.

### Objects and Advantages

It is a principle object of the present invention to expedite pattern-processing.

It is a principle object of the present invention to use massive parallelism for pattern processing.

It is a further object of the present invention to provide a storage that can store and process patterns at reasonable cost and fast speed.

In accordance with these and other objects of the present invention, the present invention discloses a distributed pattern processor comprising a three-dimensional memory (3D-M) array.

### SUMMARY OF THE INVENTION

The present invention discloses a distributed pattern processor comprising a three-dimensional memory (3D-M) array. The distributed pattern processor not only stores patterns permanently, but also processes them using massive parallelism. It comprises a plurality of storage-processing units (SPU), with each SPU comprising a pattern-processing circuit and at least a 3D-M array storing at least a pattern. The phrase “storage” is used herein because patterns are permanently stored in the 3D-M array. The 3D-M array is vertically stacked above the pattern-processing circuit. This type of integration is referred to as vertical integration, or 3D-integration. The 3D-M array is communicatively coupled with the pattern-processing circuit through a plurality of contact vias. Since they couple the storage with the processor, the contact vias are collectively referred to as inter-storage-processor (ISP) connections. As used herein, the phrase “permanent” is used in its broadest sense to mean any long-term storage; the phrase “communicatively coupled” is used in its broadest sense to mean any coupling whereby information may be passed from one element to another element.

The nature of permanent storage and vertical integration offers many advantages. First of all, because patterns are permanently stored in a same die as the pattern-processing circuit, they do not have to be transferred from an external storage during pattern processing. This avoids the bottleneck of “memory wall” faced by the von Neumann architecture. As a result, a significant speed-up can be achieved for the preferred distributed pattern processor.

Secondly, because the 3D-M array does not occupy any substrate area and its peripheral circuits only occupy a small portion of the substrate area, a majority portion of the substrate area can be used for the pattern-processing circuit. Since the peripheral circuits of the 3D-M array needs to be formed anyway, inclusion of the pattern-processing circuit adds little or no extra cost from the perspective of the 3D-M. When the 3D-M dice are used to permanently store pattern database, it would be “convenient” to include the pattern-processing capabilities into the 3D-M dice. As a result, the 3D-M dice can not only store the pattern database permanently, but also perform pattern processing for it at little or no extra cost.

Thirdly, with vertical integration, the 3D-M array and the pattern-processing circuit are physically close. Because the contact vias coupling them are short (on the order of an um in length) and numerous (tens of thousands), the ISP-connections between the 3D-M array and the pattern-processing circuit would have an extremely large bandwidth. This bandwidth is larger than the case if the 3D-array and the pattern-processing circuit were placed side-by-side on the substrate (i.e. horizontal integration, or 2D-integration), let alone the bandwidth between discrete processor and memory/storage.

Lastly, because the footprint of the SPU is the larger of the 3D-M array and the pattern-processing circuit, the SPU is smaller than the 2D-integration where its footprint is the sum of the two. With a smaller SPU, the preferred distributed pattern processor would comprise a large number of SPUs, typically on the order of tens of thousands. As a result, the preferred distributed pattern-processor die supports massive parallelism for pattern processing.

Accordingly, the present invention discloses a distributed pattern processor, comprising: an input bus for transferring a first pattern; a semiconductor substrate having transistors thereon; a plurality of storage-processing units (SPU) including a first SPU, said first SPU comprising at least a three-dimensional memory (3D-M) array and a pattern-processing circuit, wherein said 3D-M array is stacked above said substrate, said 3D-M array storing a second pattern; said pattern-processing circuit is formed on said substrate, said pattern-processing circuit performing pattern matching or pattern recognition for said first and second patterns; said 3D-M array and said pattern-processing circuit are communicatively coupled by an inter-level connection comprising a plurality of contact vias.

### BRIEF DESCRIPTION OF THE DRAWINGS

FIG. 1 is a circuit block diagram of a preferred distributed pattern processor;

FIGS. 2A-2C are circuit block diagrams of three preferred storage-processing units (SPU);

FIG. 3A is a cross-sectional view of a preferred SPU comprising at least a three-dimensional writable memory (3D-W) array; FIG. 3B is a cross-sectional view of a preferred SPU comprising at least a three-dimensional printed memory (3D-P) array;

FIG. 4 is a perspective view of a preferred SPU;

FIGS. 5A-5C are substrate layout views of three preferred SPUs.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments. Throughout the specification, the symbol “/” means “and/or”.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

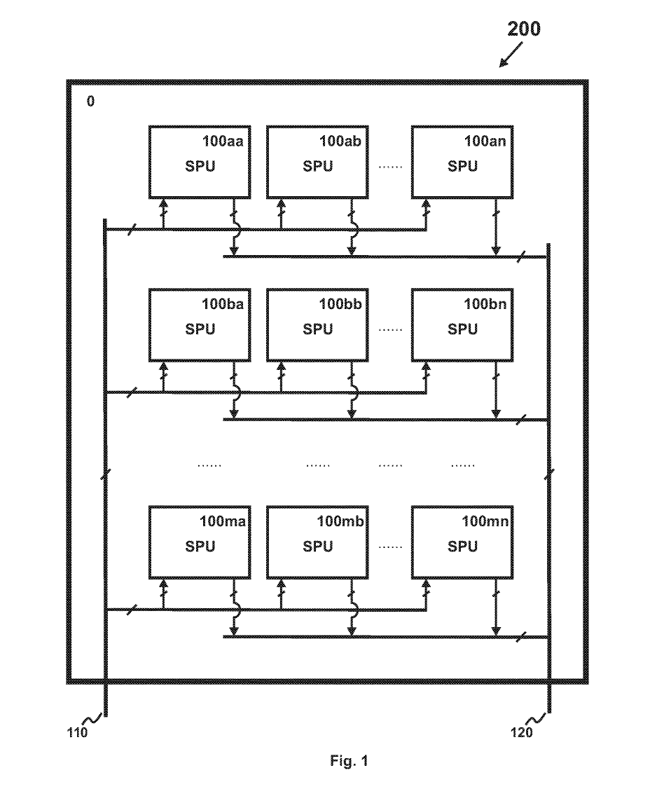

Referring now to FIG. 1, a preferred distributed pattern-processor die 200 is disclosed. It not only stores patterns permanently, but also processes them using massive parallelism. The distributed pattern-processor die 200 comprises m×n storage-processing units (SPU) 100aa-100mn. Each SPU is commutatively coupled with an input bus 110 and an output bus 120. By storing patterns permanently, the preferred distributed pattern-processor die 200 avoids the bottleneck of “memory-wall” faced by the von Neumann architecture. In addition, the preferred distributed pattern-processor die 200 comprises tens of thousands of SPUs 100aa-100mn. This large number ensures massive parallelism for pattern processing.

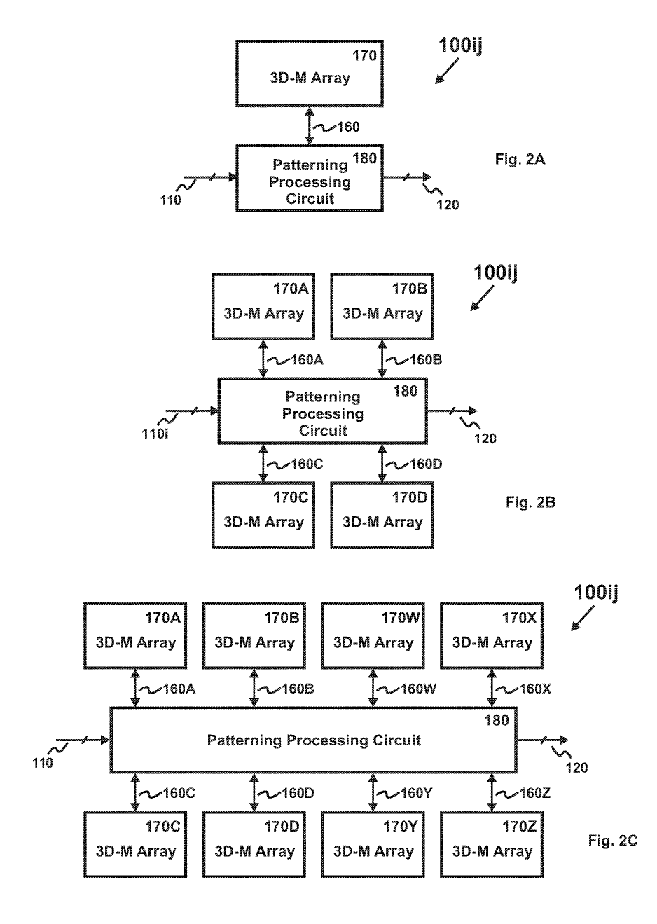

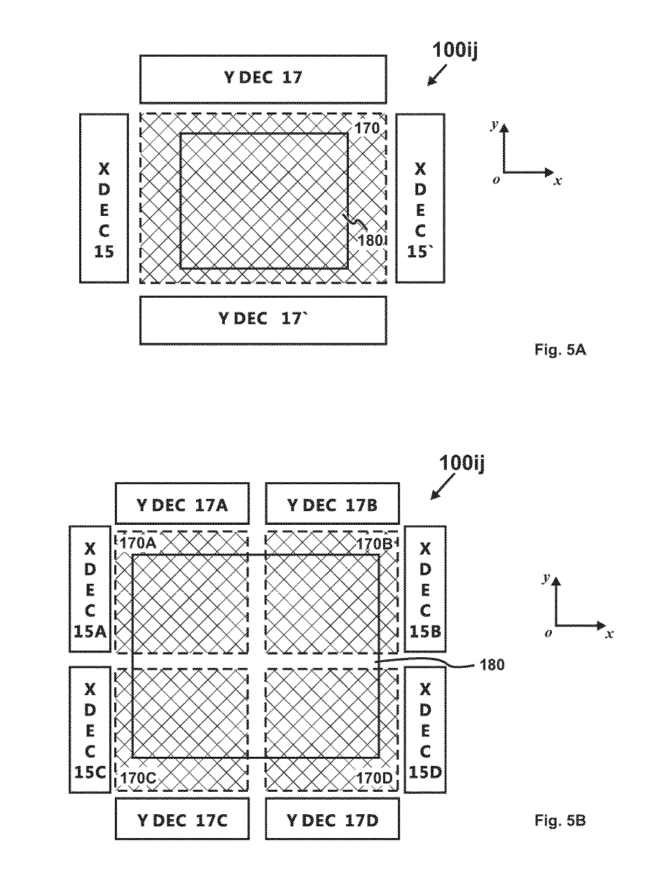

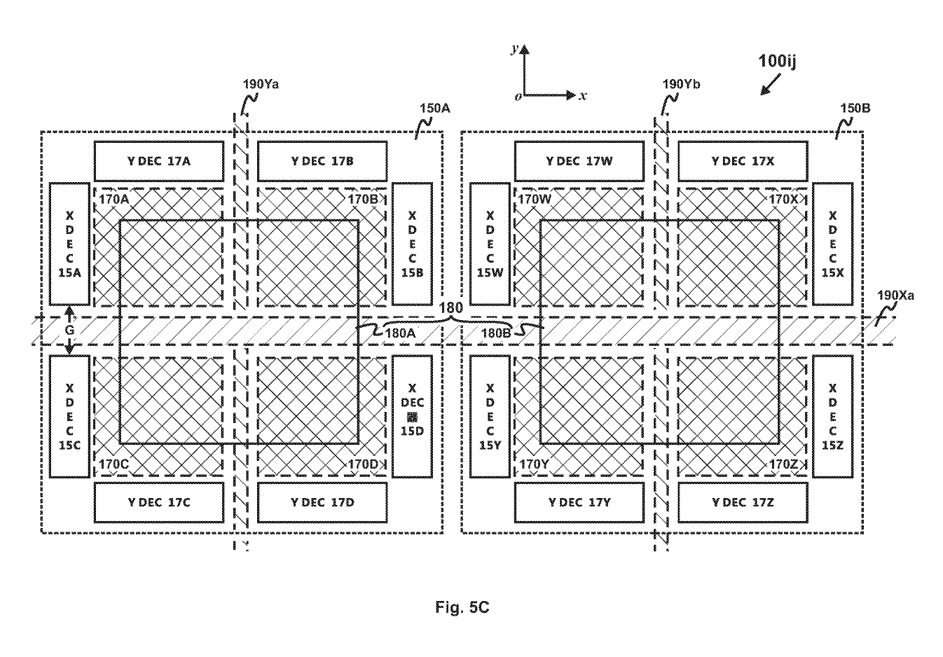

FIGS. 2A-2C discloses three preferred SPUs 100ij. Each SPU 100ji comprises a pattern-processing circuit 180 and at least a 3D-M array 170 (or, 170A-170D, 170W-170Z), which are communicatively coupled through an inter-storage-processor (ISP) connection 160 (or, 160A-160D, 160W-160Z). The 3D-M array 170 stores at least a pattern, which is checked against another pattern from the input 110 during pattern processing. In these embodiments, the pattern-processing circuit 180 serves different number of 3D-M arrays. In the first embodiment of FIG. 2A, the pattern-processing circuit 180 serves one 3D-M array 170. In the second embodiment of FIG. 2B, the pattern-processing circuit 180 serves four 3D-M arrays 170A-170D. In the third embodiment of FIG. 2C, the pattern-processing circuit 180 serves eight 3D-M array 170A-170D, 170W-170Z. As will become apparent in FIGS. 5A-5C, the more 3D-M arrays it serves, a larger area and a better function will the SPU 100ij have.

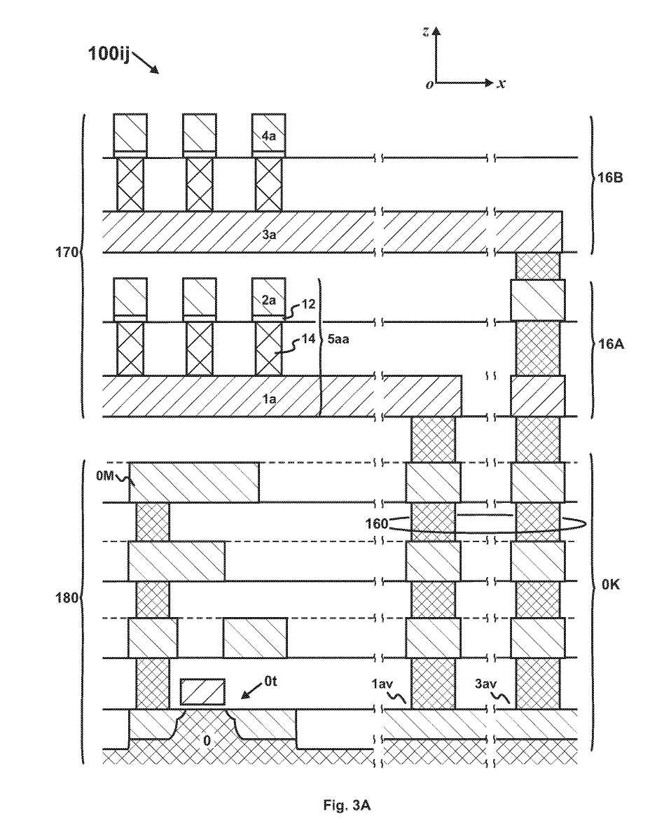

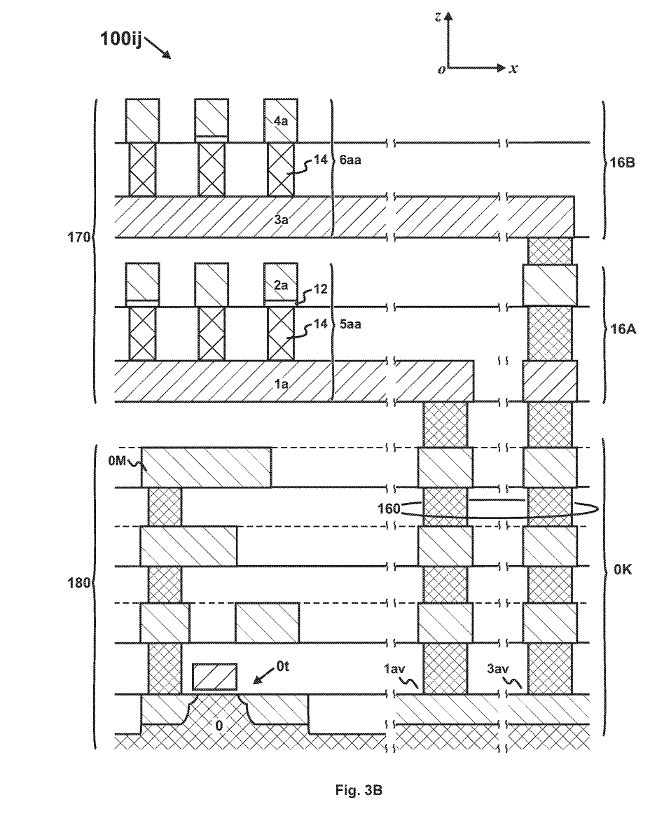

Referring now to FIG. 3A-3B, two preferred SPUs 100ij comprising at least a 3D-M array is shown. The 3D-M is generally a non-volatile memory where data can be permanently stored. The 3D-M of FIG. 3A is a 3D-W. 3D-W is a type of 3D-M whose memory cells are electrically programmable. A common 3D-W is 3D-XPoint. Other types of 3D-M include memristor, resistive random-access memory (RRAM or ReRAM), phase-change memory, programmable metallization cell (PMC), conductive-bridging random-access memory (CBRAM), and the like. Based on the number of programmings allowed, a 3D-W can be categorized into three-dimensional one-time-programmable memory (3D-OTP) and three-dimensional multiple-time-programmable memory (3D-MTP, including 3-D re-programmable memory). The 3D-OTP has been mass-produced. It can be used to store search patterns (e.g. virus signatures, network rules, acoustic models, language models, image models), because search patterns are generally only added but not modified. The 3D-MTP is a general-purpose memory. It can be used to store target patterns, e.g. user data (including user code).

The 3D-W comprises a substrate circuit OK formed on the substrate 0. A first memory level 16A is stacked above the substrate circuit OK, with a second memory level 16B stacked above the first memory level 16A. The substrate circuit OK includes the peripheral circuits of the memory levels 16A, 16B. It comprises transistors 0t and the associated interconnect OM. Each of the memory levels (e.g. 16A, 16B) comprises a plurality of first address-lines (i.e. y-lines, e.g. 2a, 4a), a plurality of second address-lines (i.e. x-lines, e.g. 1a, 3a) and a plurality of 3D-W cells (e.g. 5aa). The first and second memory levels 16A, 16B are coupled to the substrate circuit OK through contact vias 1av, 3av, respectively. Because they couple the 3D-M array 170 and the pattern-processing circuit 180, the contacts vias 1av, 3av are collectively referred to as inter-storage-processor (ISP) connections 160.

A 3D-W cell 5aa comprises a programmable layer 12 and a diode layer 14. The programmable layer 12 could be an antifuse layer (used for 3D-OTP) or a re-programmable layer (used for 3D-MTP). The diode layer 14 is broadly interpreted as any layer whose resistance at the read voltage is substantially lower than when the applied voltage has a magnitude smaller than or polarity opposite to that of the read voltage. The diode could be a semiconductor diode (e.g. p-i-n silicon diode), or a metal-oxide (e.g. TiO₂) diode.

The 3D-M of FIG. 3B is a 3D-P. The 3D-P is a type of 3D-M whose data are recorded using a printing method during manufacturing. These data are fixedly recorded and cannot be changed after manufacturing. The printing methods include photo-lithography, nano-imprint, e-beam lithography, DUV lithography, and laser-programming, etc. A common 3D-P is three-dimensional mask-programmed read-only memory (3D-MPROM), whose data are recorded by photo-lithography. Because electrical programming is not needed, a 3D-P cell can be biased at a larger voltage/current during read than a 3D-W cell. Thus, the 3D-P is faster than the 3D-W. The 3D-P can be used to store fixed search patterns (e.g. acoustic models and language models). With a high speed, it can realize high-performance pattern processing (e.g. natural language processing and real-time translation).

3D-P has at least two types of 3D-P cells: a high-resistance 3D-P cell 5aa, and a low-resistance 3D-P cell 6aa. The low-resistance 3D-P cell 6aa comprises a diode layer 14, while the high-resistance 3D-P cell 5aa comprises a high-resistance layer 12. As an example, the high-resistance layer 12 is a layer of silicon oxide (SiO₂). This high-resistance layer 12 is physically removed at the location of the 3D-P cell 6aa through mask programming.

In a 3D-M, each memory level comprises at least a 3D-M array. A 3D-M array is a collection of 3D-M cells in a memory level that share at least one address-line. The 3D-M array on the topmost memory level is referred to as the topmost 3D-M array. The memory level below the topmost memory level is referred to as intermediate memory level. A 3D-M die comprises a plurality of 3D-M blocks. Each 3D-M block comprises a topmost 3D-M array and all 3D-M arrays bound by the projection of the topmost 3D-M array on each intermediate memory level.

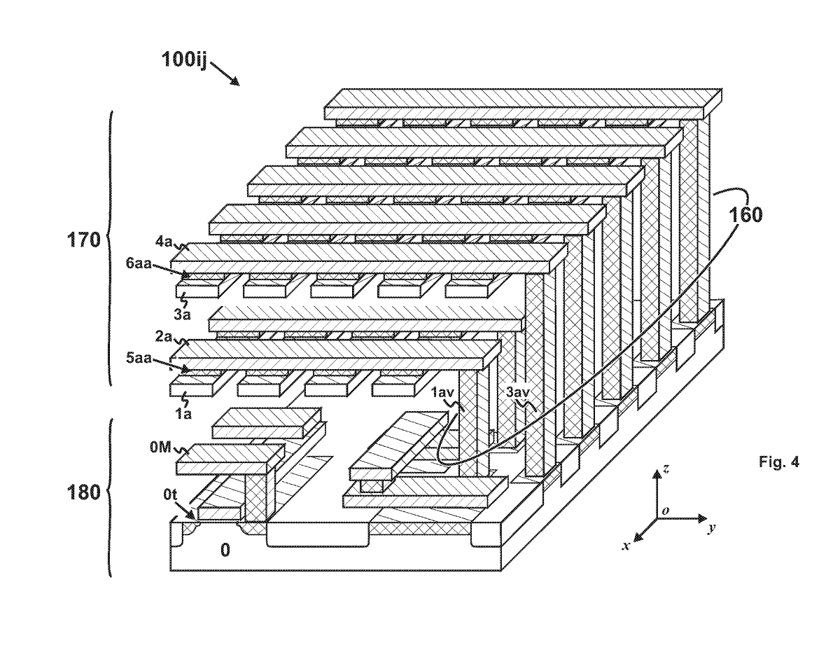

Referring now to FIG. 4, a perspective view of the SPU 100ij is shown. The 3D-M array 170 storing patterns are vertically stacked above the substrate 0. The pattern-processing circuit 180 is located on the substrate 0 and is at least partially covered by the 3D-M array 170. For this type of vertical integration, the footprint of the SPU 100ij is the larger one of the 3D-M array 170 and the pattern-processing circuit 180. Accordingly, the preferred SPU 100ij has a smaller size than the case if the 3D-array and the pattern-processing circuit were placed side-by-side on the substrate 0. For a die of given size, the distributed pattern processor 200 comprises more SPUs and therefore, supports more parallelism. In addition, the 3D-M array 170 is communicatively coupled with the pattern-processing circuit 180 through contact vias 1av, 3av, which are part of the ISP-connections 160. Because the contact vias 1av, 3av have a large number (tens of thousands) and a short length (um), the ISP-connections 160 can achieve a large bandwidth.

Referring now to FIGS. 5A-5C, the substrate layout views of three preferred SUPs 100ij are shown. The embodiment of FIG. 5A corresponds to the SPU 100iji of FIG. 2A. The pattern-processing circuit 180 serves one 3D-M array 170. It is fully covered by the 3D-M array 170. The 3D-M array 170 has four peripheral circuits, including x-decoders 15, 15′ and y-decoders 17, 17′. The pattern-processing circuit 180 is bound by these four peripheral circuits. Because the 3D-M array 170 is stacked above the substrate 0, but not formed on the substrate 0, its projection on the substrate 0, not the 3D-P array itself, is shown in the area enclosed by dash line.

In this preferred embodiment, because it is bound by four peripheral circuits, the area of the pattern-processing circuit 180 must be smaller than that of the 3D-M array 170. As a result, the pattern-processing circuit 180 has limited functions. It is more suitable for simple pattern processing (e.g. string match and code match). Apparently, complex pattern processing (e.g. voice recognition, image recognition) requires a larger area to facilitate the layout of the pattern-processing circuit 180. FIGS. 5B-5C discloses two preferred pattern-processing circuits 180 with larger areas and more functions.

The embodiment of FIG. 5B corresponds to the SPU 100ij of FIG. 2B. The pattern-processing circuit 180 serves four 3D-M arrays 170A-170D. Each 3D-M array (e.g. 170) has two peripheral circuits (e.g. x-decoder 15A and y-decoder 17A). Below these four 3D-M arrays 170A-170D, the pattern-processing circuit 180 can be formed. Apparently, the pattern-processing circuit 180 of FIG. 5B could be four times as large as that of FIG. 5A. It can perform complex pattern-processing functions.

The embodiment of FIG. 5C corresponds to the SPU 100ij of FIG. 2C. The pattern-processing circuit 180 serves eight 3D-M arrays 170A-170D, 170W-170Z. These 3D-M arrays are divided into two sets: a first set 150A includes four 3D-M arrays 170A-170D, and a second set 150B includes four 3D-M arrays 170W-170Z. Below the four 3D-M arrays 170A-170D of the first set 150A, a first component 180A of the pattern-processing circuit 180 is formed. Similarly, below the four 3D-M array 170W-170Z of the second set 150B, a second component 180B of the pattern-processing circuit 180 is formed. In this embodiment, adjacent peripheral circuits (e.g. adjacent x-decoders 15A, 15C, or, adjacent y-decoders 17A, 17B) are separated by physical gaps (e.g. G). These physical gaps allow the formation of the routing channel 190Xa, 190Ya, 190Yb, which provide coupling between different components 180A, 180B, or between different pattern-processing circuits. Apparently, the pattern-processing circuit 180 of FIG. 5C could be eight times as large as that of FIG. 5A. It can perform more complex pattern-processing functions.

In some embodiments of the present invention, the pattern-processing circuit 180 may perform partial pattern processing. For example, the pattern-processing circuit 180 only performs a simple pattern processing (e.g. simple feature extraction and analysis). After being filtered by the simple pattern processing, the remaining patterns are sent to an external processor (e.g. CPU, GPU) to complete the full pattern processing. Because a majority of patterns will be filtered by the simple pattern processing, the patterns output from the pattern-processing circuit 180 are far fewer than the original patterns. This can alleviate the bandwidth requirement on the output bus 120.

In the preferred distributed pattern processor 200, the SPU 100ij could be processor-like or storage-like. The processor-like SPU appears to a user like a processor. It performs pattern processing for an external user data using its embedded search-pattern database. To be more specific, the 3D-M array 170 in the SPU 100ij stores at least a portion of the search-pattern database; the input data 110 of the SPU 100ij include the user data (e.g. network packets), which are usually generated real-time; and, the pattern-processing circuit 100ij of the SPU 100ij performs pattern matching or pattern recognition. Because the 3D-M array 170 and the pattern-processing circuit 180 have fast ISP-connections 160, the preferred distributed pattern processor 200 offers a faster pattern-processing speed than the conventional von Neumann architecture.

On the other hand, the storage-like SPU appears to a user like a storage. Its primary purpose is to permanently store user data, with a secondary purpose of performing pattern-processing using its embedded pattern-processing circuit. To be more specific, the 3D-M array 170 in the SPU 100ij permanently stores at least a portion of a user database; the input data 110 of the SPU 100ij include at least a search pattern; and, the pattern-processing circuit 100ij of the SPU 100ij performs pattern matching or pattern recognition. Just like the flash memory, a plurality of distributed pattern-processor dice 200 can be packaged into a storage card (e.g. an SD card, a TF card) or a solid-state drive (SSD). They can be used to store mass user data (e.g. in a user-data archive). Because each SPU 100ij in each distributed pattern-processor die 200 has its own pattern-processing circuit 180, this pattern-processing circuit 180 only needs to process the user data stored in the 3D-M array 170 of the same SPU 100ij. As a result, no matter how large is the capacity of a storage card (or, a solid-state drive), the processing time for the whole storage card (or, the whole solid-state drive) is similar to the processing time for a single SPU 100ij. This is unimaginable for the conventional von Neumann architecture.

A big difference between the present invention and prior art is that the 3D-M arrays in a storage-like SPU are the final storage place for the user data. In prior art, the memory embedded in a processor is used as a cache and only temporarily stores user data; and, all user data are permanently stored in external storage (e.g. hard drive, optical drive, tape). This arrangement causes the bottleneck of “memory wall” faced by the von Neumann architecture. In addition, prior art cannot simply switch to the permanent-storage approach used in the present invention. Assume that prior art adopted the permanent-storage approach, i.e. the embedded memory in the processor permanently stores user data. Once the embedded memory is full, the processor can only serve the inside data, but not any outside data. Thus, a large number of processors are required for mass data. Since the conventional processors are expensive, prior art using the permanent-storage approach would incur a high price tag.

In contrast, for the SPU 100ji disclosed in the present invention, the pattern-processing circuit 180 is formed at the same time as the peripheral circuits of the 3D-M array 170. Because the peripheral circuits are needed for the 3D-M anyway, adding the fact that the peripheral circuits only occupy a small area on the substrate 0 and most substrate area can be used to form the pattern-processing circuit 180 (FIGS. 5A-5C), the inclusion of the pattern-processing circuit 180 is nearly free from the perspective of the 3D-M. Overall, a storage-like distributed pattern processor 200 can permanently store user data like a conventional storage. With little or no extra cost, it can perform massively parallel pattern processing for the pattern database stored therein.

In the following paragraphs, several applications of the distributed pattern processor are disclosed. One application is big-data processor. Big-data processor is used for big-data analytics (e.g. financial data mining, e-commerce data mining, bio-informatics). Big data are generally unstructured data or semi-structured data which cannot be analyzed using relational database. To improve its pattern-processing speed, a storage-like distributed pattern processor 200 is preferably used: the input data 110 include search keywords or other regular expressions; the 3D-M array 170 stores at least a portion of the big data; and, the pattern-processing circuit 180 performs pattern processing. In the big-data processor, the 3D-M is preferably a 3D-MTP. It can be used to store big data.

Another application is anti-malware processor. It is used for network security and/or anti-virus operations. Network security applications may take the processor-like approach: the input data 110 include at least a network packet; the 3D-M array 170 stores at least a network rule and/or a virus signature; and, the pattern-processing circuit 180 performs pattern processing. Anti-virus operations may take either the processor-like approach or the storage-like approach. For the processor-like approach, the input data 110 are at least a portion of the user data stored in a computer, the 3D-M array 170 stores at least a virus signature; and, the pattern-processing circuit 180 performs pattern processing. For the storage-like approach, the input data 110 include a virus signature from a virus signature database; the 3D-M array 170 stores at least a portion of the user database; and, the pattern-processing circuit 180 performs pattern processing. For the processor-like approach, the 3D-M is preferably a 3D-OTP or 3D-MTP. It can be used to store the network rule database and/or the virus signature database. For the storage-like approach, the 3D-M is preferably a 3D-MTP. It can be used to store the user database.

The distributed pattern processor 200 may also used for voice recognition and/or image recognition. Recognition can be performed using either the processor-like approach or the storage-like approach. For the processor-like approach, the input data 110 include at least a portion of voice/image data collected by at least a sensor; the 3D-M array 170 store at least a recognition model (e.g. an acoustic model, a language model, an image model); and, the pattern-processing circuit 180 performs pattern processing. For the storage-like approach, the input data 110 include the search voice/image patterns; the 3D-M array 170 stores at least a portion of the voice/image archives; and, the pattern-processing circuit 180 performs pattern processing. For the processor-like approach, the 3D-M is preferably a 3D-P, 3D-OTP or 3D-MTP. It can be used to store the acoustic model database, the language model database and/or the image model database. For the storage-like approach, the 3D-M is preferably a 3D-MTP. It can be used to store the voice/image archives.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

What is claimed is:

1. A distributed pattern processor, comprising:
an input bus for transferring a first pattern;
a semiconductor substrate having transistors thereon;
a plurality of storage-processing units (SPU) including a first SPU, said first SPU comprising at least a three-dimensional memory (3D-M) array and a pattern-processing circuit, wherein
said 3D-M array is stacked above said substrate, said 3D-M array storing a second pattern;
said pattern-processing circuit is formed on said substrate, said pattern-processing circuit performing pattern matching or pattern recognition for said first and second patterns;
said 3D-M array and said pattern-processing circuit are communicatively coupled by an inter-level connection comprising a plurality of contact vias.

2. The distributed pattern processor array according to claim 1, further comprising a second SPU formed side-by-side with said first SPU, wherein said first and second SPUs are both communicatively coupled with said input bus.

3. The distributed pattern processor array according to claim 2, further comprising an output bus, wherein said first and second SPUs are both communicatively coupled with said output bus.

4. The distributed pattern processor array according to claim 1, wherein said 3D-M is three-dimensional writable memory (3D-W).

5. The distributed pattern processor array according to claim 4, wherein said 3D-W is three-dimensional one-time-programmable memory (3D-OTP).

6. The distributed pattern processor array according to claim 4, wherein said 3D-W is three-dimensional multiple-time-programmable memory (3D-MTP).

7. The distributed pattern processor array according to claim 6, wherein said 3D-MTP is 3D-XPoint.

8. The distributed pattern processor array according to claim 1, wherein said 3D-M is three-dimensional printed memory (3D-P).

9. The distributed pattern processor array according to claim 8, wherein said 3D-P is three-dimensional mask-programmed read-only memory (3D-MPROM).

10. The distributed pattern processor array according to claim 1, wherein said 3D-M array at least partially covers said pattern-processing circuit.

11. The distributed pattern processor array according to claim 1, wherein said pattern-processing circuit is covered by at least a first 3D-M array and a second 3D-M array.

12. The distributed pattern processor array according to claim 11, further comprising a gap between said first 3D-M array and said second 3D-M array.

13. The distributed pattern processor array according to claim 12, further comprising a routing channel in said gap.

14. The distributed pattern processor array according to claim 1 being a big-data processor, wherein
said first pattern is a search pattern;
said second pattern is a target pattern; and
said 3D-M array stores at least a portion of big data

15. The distributed pattern processor array according to claim 1 being a anti-malware processor, wherein
said first pattern is a target pattern;
said second pattern is a search pattern; and
said 3D-M array stores at least a virus signature and/or a network rule.

16. The distributed pattern processor array according to claim 1 being a anti-malware processor, wherein
said first pattern is a search pattern;
said second pattern is a target pattern; and
said 3D-M array stores at least a portion of user data.

17. The distributed pattern processor array according to claim 1 being a voice-recognition processor, wherein
said first pattern is a target pattern;
said second pattern is a search pattern;
said 3D-M array stores at least an acoustic model and/or a language model.

18. The distributed pattern processor array according to claim 1 being a voice-recognition processor, wherein
said first pattern is a search pattern;
said second pattern is a target pattern;
said 3D-M array stores at least a portion of voice data.

19. The distributed pattern processor array according to claim 1 being an image-recognition processor, wherein
said first pattern is a target pattern;
said second pattern is a search pattern;
said 3D-M array stores at least a language model.

20. The distributed pattern processor array according to claim 1 being an image-recognition processor, wherein
said first pattern is a search pattern;
said second pattern is a target pattern;
said 3D-M array stores at least a portion of image data.
